(19) United States
(12) Patent Application Publication
(10) Pub. No.: US 2015/0064504 A1
(43) Pub. Date: Mar. 5, 2015

(54) BATTERY MODULE HAVING CONNECTING TAB

(71) Applicant: SAMSUNG SDI CO., LTD., Yongin-si (KR)

(72) Inventors: Bong-Young KIM, Yongin-si (KR); Chi-Hyung AHN, Yongin-si (KR)

(21) Appl. No.: 14/455,022

(22) Filed: Aug. 8, 2014

(30) Foreign Application Priority Data
Aug. 29, 2013 (KR) 10-2013-0103291

(51) Int. Cl. H01M 2/20; H01M 10/42

(52) U.S. Cl. CPC H01M 2/202; H01M 10/4257; H01M 2010/4271
USPC 429/7

(57) ABSTRACT

Disclosed is a battery module including a plurality of rechargeable batteries, a protective circuit board controlling charging and discharging of the rechargeable batteries, and a connecting tab for combining the rechargeable batteries with the protective circuit board such that the connecting tab is provided with a catching protrusion which is inserted into a hole of the protective circuit board and thereby supports the protective circuit board.

### CROSS-REFERENCE TO RELATED APPLICATIONS

This application claims priority to and the benefit of Korean Patent Application No. 10-2013-0103291 filed in the Korean Intellectual Property Office on Aug. 29, 2013, the entire contents of which are incorporated herein by reference.

### BACKGROUND

1. Field

The described technology relates generally to a battery module. More particularly, the described technology relates generally to a battery module having an improved structure of a connecting tab.

2. Description of the Related Technology

A rechargeable battery differs from a primary battery in that it can be repeatedly charged and discharged, while the latter is incapable of being recharged.

A low-capacity rechargeable battery is used in small electronic devices such as mobile phones, laptop computers, and camcorders, while a high-capacity rechargeable battery is widely used as a power source for driving a motor of a hybrid vehicle and the like.

In addition, a high-capacity battery module normally includes a plurality of rechargeable batteries connected in series, and a rechargeable battery may be formed in a cylindrical or a prismatic shape.

The battery module is installed with a protective circuit board which measures and controls voltage and current of each rechargeable battery.

The protective circuit board is installed with various circuit devices for measuring the current, voltage, and temperature of the rechargeable batteries, and a control circuit to prevent overcharge and overcurrent of the rechargeable battery.

To support the protective circuit board, a holder is required, resulting in increased weight and volume of the battery module, a complicated manufacturing process, and high manufacturing cost.

The above information disclosed in this Background section is only for enhancement of understanding of the background of the described technology and therefore it may contain information that does not form the prior art that is already known in this country to a person of ordinary skill in the art

### SUMMARY OF CERTAIN INVENTIVE ASPECTS

Accordingly, the present invention has been made in an effort to solve the problem described above, and the purpose of the present invention is to provide a battery module which can stably support a protective circuit board.

According to an exemplary embodiment, a battery module includes a plurality of rechargeable batteries, a protective circuit board controlling charging and discharging of rechargeable batteries, and a connecting tab for combining the rechargeable batteries with the protective circuit board, and the connecting tab has a catching protrusion that is inserted into a hole of the protective circuit board and supports the protective circuit board formed in the connecting tab.

The connecting tab includes a bonding portion fixed to the rechargeable battery and a supporting portion protruding upward from the bonding portion, and a catching protrusion may be formed protruding at a lateral end of the supporting portion, and two catching protrusions, in the supporting portion, are disposed apart in a height direction of the supporting portion such that a lateral end of the protective circuit board can be inserted between these catching protrusions.

A bonding protrusion to be welded to the rechargeable battery may be formed in the bonding portion, and the connecting tab can electrically connect the neighboring rechargeable batteries.

A lower tab is installed at a lower part of the rechargeable battery, and the lower tab may include the bonding portion fixed to the rechargeable batteries and a signal line protruding upward from the bonding portion and being inserted in a hole of the protective circuit board.

The supporting portion may be formed with a protruding portion contacting with a bottom side of the protective circuit board and a curved portion curving in a direction from a frontal side of the supporting portion toward the bonding portion.

An embossed supporting portion fitted into the supporting portion and contacting with the bottom side of the protective circuit board may be formed in the supporting portion, and the supporting portion may have a concavo-convex portion with alternately arranged convex portions and recess portions.

The convex portion and the recess portion may be formed in a height direction of the supporting portion and further includes a case in which the rechargeable batteries are stored, and the case includes a first receiving portion and a second receiving portion such that a first fastener of a concavo-convex shape is formed in the first receiving portion and a second fastener fitted into the first fastener is formed in the second receiving portion.

A lower protrusion for supporting the rechargeable batteries from below may be formed in the first receiving portion and the second receiving portion, and a supporting protrusion for supporting the protective circuit board may be formed in the case.

A plurality of supporting protrusions are disposed apart in a height direction of the case such that an end portion of the protective circuit board can be inserted and installed between these supporting protrusions.

According to the present embodiment, since a catching protrusion is formed in the connecting tab, the protective circuit board can be stably supported by the connecting tab.

A support assembly device for a protection circuit board of a battery module having a plurality of batteries, the assembly comprising a connecting tab coupling the batteries to the protective circuit board; a catching protrusion formed on the connecting tab that is sized and positioned to be positioned within a hole in the protection circuit board to support the protection circuit board.

### BRIEF DESCRIPTION OF THE DRAWINGS

FIG. 1 is a perspective view of a battery module according to a first exemplary embodiment.

FIG. 2 is a perspective view of a protective circuit board according to the first exemplary embodiment.

FIG. 3 is a perspective view of a first connecting member according to the first exemplary embodiment.

FIG. 4 is a cross-sectional view of a connecting member and a protective circuit board combined together according to the first exemplary embodiment.

FIG. 5 is a cross-sectional view of the battery module according to the first exemplary embodiment.

FIG. 6 is a perspective view of a first connecting tab according to a second exemplary embodiment.

FIG. 7 is a perspective view of a first connecting tab according to a third exemplary embodiment.

FIG. 8 is a perspective view of a first connecting tab according to a fourth exemplary embodiment.

FIG. 9 is a perspective view of a first connecting tab according to a fifth exemplary embodiment.

### DETAILED DESCRIPTION OF CERTAIN INVENTIVE EMBODIMENTS

The present invention will be described more fully hereinafter with reference to the accompanying drawings, in which exemplary embodiments are shown.

As those skilled in the art would realize, the described embodiments may be modified in various different ways, all without departing from the spirit or scope of the present invention.

Like reference numerals designate like elements throughout the specification and drawings.

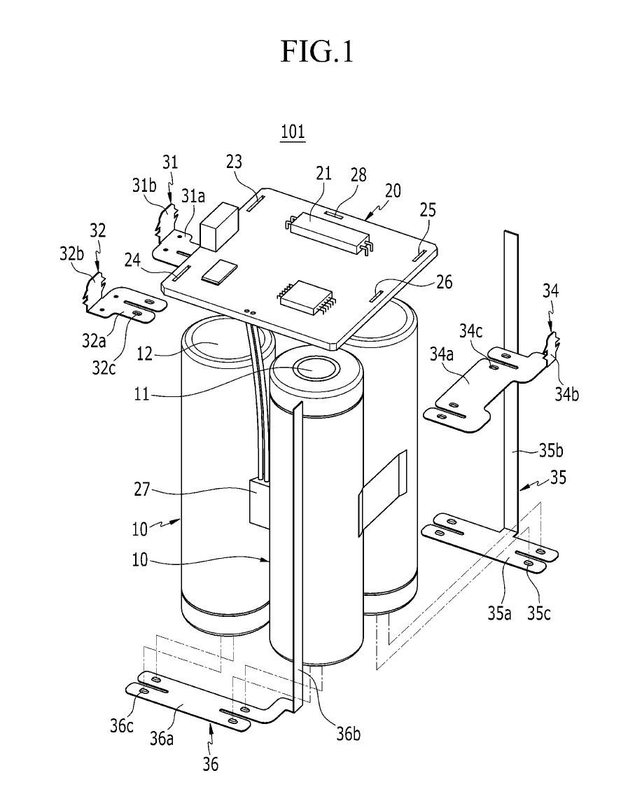

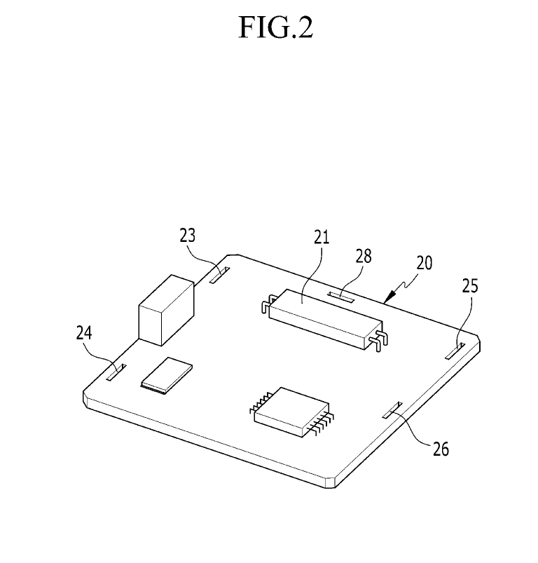

FIG. 1 is a perspective view of a battery module according to a first exemplary embodiment, and FIG. 2 is a perspective view of a protective circuit board according to a first exemplary embodiment.

Referring to FIG. 1 and FIG. 2, the battery module 101 according to the present exemplary embodiment comprises a plurality of rechargeable batteries 10, a connecting member which electrically connects the rechargeable batteries 10, and a protective circuit board 20 connected with rechargeable batteries 10.

The rechargeable batteries 10, according to the present exemplary embodiment, are formed in a cylindrical shape and include a case, an electrode assembly with a positive electrode and a negative electrode to be inserted in the case, a cap plate connected to a case opening, and a terminal protruding out of the case.

In the present exemplary embodiment, a cylindrical rechargeable battery is taken as an example, however it is not limited thereto, and it should be understood that a rechargeable battery may be formed as a square or in other shapes.

The rechargeable battery 10 is connected in series with its neighboring rechargeable battery through the connecting member.

The rechargeable battery 10 according to the present exemplary embodiment is formed of four rechargeable batteries coupled in series and electrically connected to each other.

However, the present invention is not limited thereto. For example, the rechargeable battery may be formed in a 5S2P structure in which five rechargeable batteries connected in series are coupled in parallel. Therefore, the rechargeable batteries can be freely connected in series or in parallel.

The protective circuit board 20 is disposed above the rechargeable batteries 10, and is installed with a plurality of protective circuit devices 21.

In addition, holes 23, 24, and 25 in which the connecting member is inserted are formed in the protective circuit board 20.

A sensor 27 is also connected to the protective circuit board to measure temperature of the rechargeable batteries 10.

An insulating tape for insulation is applied on a bottom side of the protective circuit board 20.

The connecting member includes a first connecting tab 31 combining with one rechargeable battery, a second connecting tab 32 combining with another neighboring rechargeable battery, and a third connecting tab 34 connecting the rechargeable batteries in series.

The first connecting tab 31 includes a bonding portion 31a fixed to the rechargeable battery 10, and a supporting portion 31b protruding upward from the bonding portion 31a and thereby combining with the protective circuit board 20.

The bonding portion 31a is disposed in parallel with a top side of the rechargeable battery 10, and a bonding protrusion to be welded to a terminal of the rechargeable battery 10 is formed in the bonding portion 31a.

The supporting portion 31b bent in a vertical direction of the bonding portion 31a protrudes above the protective circuit board, and a catching protrusion is formed at a lateral side of the supporting portion 31b.

The supporting portion 31b is inserted in the hole 23 formed in the protective circuit board 20, and protrudes above the protective circuit board 20. The supporting portion 31b protruding above the protective circuit board 20 operates as a negative terminal.

The second connecting tab 32 includes a bonding portion 32a fixed to the rechargeable battery 10, and a supporting portion 32b protruding upward from the bonding portion 32a and thereby combining with the protective circuit board 20.

The bonding portion 32a is disposed in parallel with the top side of the rechargeable battery 10, and a bonding protrusion 32c to be welded to a terminal of the rechargeable battery 10 is formed in the bonding portion 32a.

The supporting portion 32b bent in a vertical direction of the bonding portion 32a and thereby protruding above the protective circuit board 20 operates as a positive terminal.

The third connecting tab 34 includes a bonding portion 34a fixed to a rechargeable battery 10, and a supporting portion 34b protruding above from the bonding portion 34a and thereby combining with the protective circuit board 20.

The bonding portion 34a is formed in an elongated plate shape to connect two neighboring rechargeable batteries 10 in series, and a bonding protrusion 34c in the bonding portion 34a is formed down toward the rechargeable battery 10.

The supporting portion 34b bent in a vertical direction of the bonding portion 34a protrudes above the protective circuit board, and a catching protrusion is formed outward at a lateral side of the supporting portion 34b.

Further, the battery module 101 includes a first lower tab 35 and a second lower tab 36.

The first lower tab 35 includes a bonding portion 35a fixed to the rechargeable batteries 10 and a signal line 35b protruding upward from the bonding portion 35a.

The bonding portion 35a is formed in an elongated plate shape to connect two neighboring rechargeable batteries 10 in series, and a bonding protrusion 35c in the bonding portion 35a is formed up toward the rechargeable battery.

The signal line 35b is formed elongated in a height direction of the rechargeable battery 10 such that it is inserted in a hole 28 of the protective circuit board 20 and is connected with the protective circuit board 20.

The second lower tab 36, like the first connecting tab 35, includes a bonding portion 36a fixed to rechargeable batteries 10 and a signal line 36b protruding upward from the bonding portion 36a.

The bonding portion 36a is formed in an elongated plate shape to connect two neighboring rechargeable batteries 10 in series, and a bonding protrusion 36c in the bonding portion 36a is formed up toward the rechargeable battery 10.

The signal line 36b is formed elongated in a height direction of the rechargeable battery 10 such that it is inserted in a hole 26 of the protective circuit board 20 and is connected with the protective circuit board 20.

The first lower tab 35 and the second lower tab 36 not only connect the rechargeable batteries in series, but also transmit state information about voltage and current of the rechargeable battery 10 to the protective circuit board 20 by combining with the protective circuit board 20.

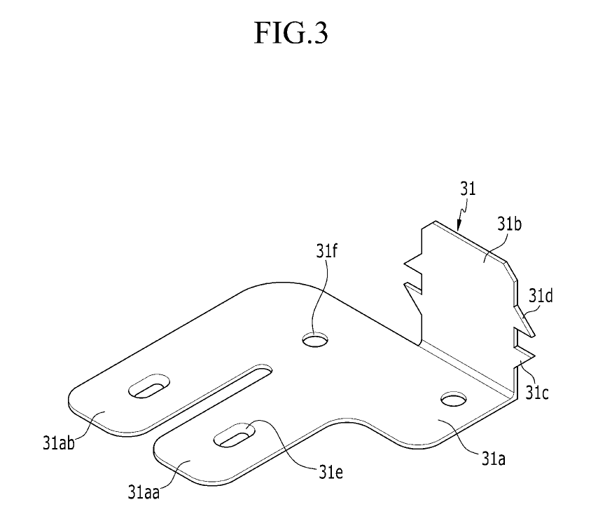

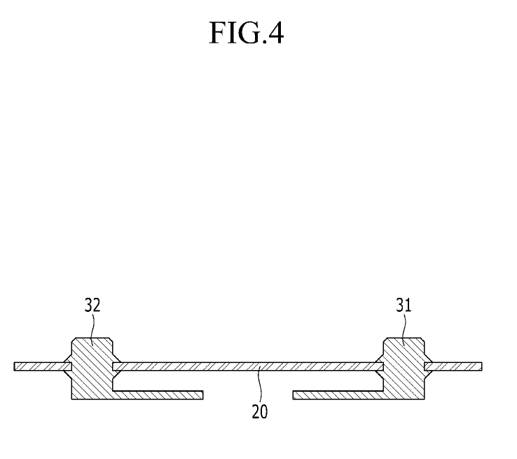

FIG. 3 is a perspective view of a second connecting member according to the first exemplary embodiment, and FIG. 4 is a cross-sectional view of the protective circuit board combined with the connecting member according to the first exemplary embodiment.

Referring to FIG. 3 and FIG. 4, the first connecting tab 31 includes the bonding portion 31a fixed to the rechargeable battery 10, and the supporting portion 31b protruding upward from the bonding portion 31a and thereby combining with the protective circuit board 20.

The bonding portion 31a is disposed in parallel with the top side of the rechargeable battery 10 such that two bonding branches 31aa and 31ab are formed in the bonding portion 31a.

The bonding branches 31aa and 31ab are integrally formed with the bonding portion 31a, and are respectively disposed apart.

A bonding protrusion 31e to be welded to the terminal of the rechargeable battery 10 is formed at each bonding branch 31aa and 31ab.

In addition, a plurality of holes 31f may be formed in the bonding portion 31a.

The supporting portion 31b bent in a vertical direction of the bonding portion 31a protrudes upward from the bonding portion 31a, and catching protrusions 31c and 31d are formed protruding at a lateral side of the supporting portion 31b.

The supporting portion 31b is inserted in the hole 24 of the protective circuit board 20, and protrudes above the protective circuit board 20.

These catching protrusions 31c and 31d are formed protruding from both lateral sides of the supporting portion such that two catching protrusions are disposed apart at one lateral side of the supporting portion.

The protective circuit board 20 is inserted and fixed between an upper catching protrusion 31d and a lower catching protrusion 31c.

The upper catching protrusion 31d passes through the hole 23, and is disposed above the hole 23 so as to support the protective circuit board 20 from above.

The lower catching protrusion 31c supports the protective circuit 20 from below the hole 23.

As a result, the protective circuit board 20 can be stably fixed by the upper catching protrusion 31d and the lower catching protrusion 31c.

Since a catching protrusion is also created in the second connecting tab 32 and in the third connecting tab 34, the supporting portion 31b in the second connecting tab 32 is inserted in the hole 24 such that the protective circuit board 20 is supported both from above and from below.

As described above, once the catching protrusion forming the connecting member is created in the first connecting tab 31, in the second connecting tab 32, and in the third connecting tab 34, the connecting member can stably support the protective circuit board 20 without an extra holder.

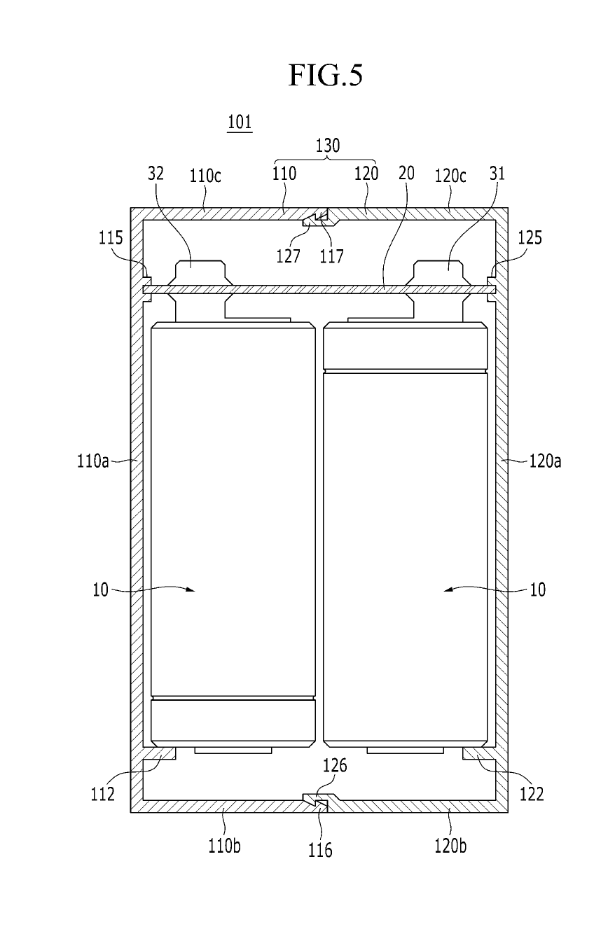

FIG. 5 is a cross-sectional view of the battery module according to the first exemplary embodiment.

Referring to FIG. 5, the battery module 101 according to the exemplary embodiment further includes a case 130 in which the rechargeable batteries are stored.

The case 130 includes a first receiving portion 110 and a second receiving portion 120 which is detachable from the first one, and is provided with a space in which the rechargeable batteries 10 are stored by combining the first receiving portion 110 with the second receiving portion 120.

A first upper fastener 117 is formed at a top side 110c of the first receiving portion 110 so as to be combined with the second receiving portion 120, and is disposed at an edge portion of the first receiving portion in a direction from the first receiving portion 110 toward the second receiving portion 120.

A second upper fastener 127 is also formed at a top side 120c of the second receiving portion 120 so as to be combined with the first receiving portion 110, and is disposed at an edge portion of the second receiving portion 120 in a direction from the second receiving portion 120 toward the first receiving portion 110.

The first upper fastener 117 formed in the first receiving portion 110 is created in a concavo-convex shape, as is the second upper fastener 127 formed in the second receiving portion 120.

These upper fasteners 117 and 127 are mutually fitted so as to support the first receiving portion 110 and the second receiving portion 120.

On the other hand, a first lower fastener 116 is formed at a bottom side 110b in the first receiving portion 110 so as to be combined with the second receiving portion 120, and a second lower fastener 126 is also formed at a bottom side 120b in the second receiving portion so as to be combined with the first lower fastener 116.

The first lower fastener 116 is formed in a concavo-convex shape, as is the second upper fastener 126.

These lower fasteners 116 and 126 are mutually fitted to support the first receiving portion 110 and the second receiving portion 120.

In addition, lower protrusions 112 and 122 for supporting the rechargeable batteries 10 from below are formed in the first receiving portion 110 and the second receiving portion 120.

The lower protrusions 112 and 122 are formed protruding inward respectively from an inner circumferential surface of the first receiving portion 110 and the second receiving portion 120.

The bottom sides of the rechargeable batteries 10 contact and are supported by the lower protrusions 112 and 122.

A supporting protrusion 115 for supporting the protective circuit board 20 is formed in the first receiving portion 110, and protrudes inward from an inner circumferential surface 110a of the first receiving portion 110.

Two supporting protrusions 115 are disposed apart while protruding in a height direction of the first receiving portion, and an edge portion of the protective circuit board 20 is inserted between them.

Supporting protrusions 125 are formed to support the protective circuit board 20 such that they protrude inward from an inner circumferential surface 120a of the second receiving portion.

Two supporting protrusions 125 are disposed apart while protruding in a height direction of the second receiving portion, and an edge portion of the protective circuit board 20 is inserted between them.

As described above, once these supporting protrusions 115 and 125 are formed in the first receiving portion 110 and the second receiving portion 120, an extra holder is not required because the protective circuit board 20 can be stably supported by the case 130 along with the connecting member.

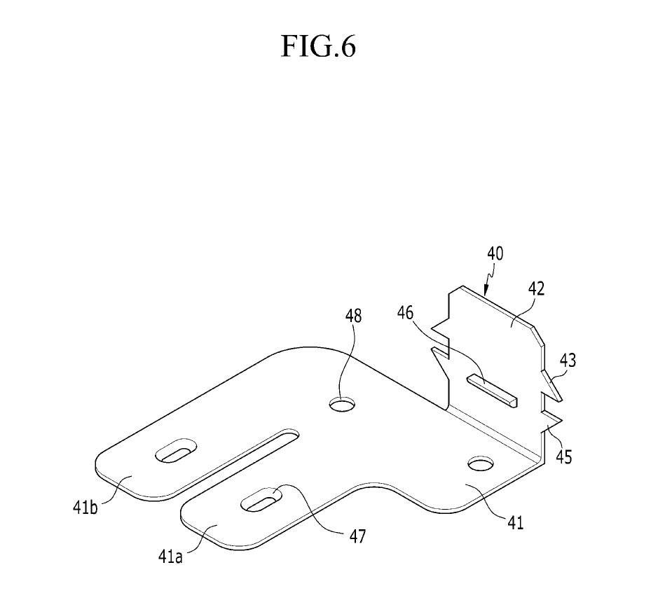

FIG. 6 is a perspective view of a first connecting tab according to a second exemplary embodiment.

Referring to FIG. 6, a first connecting tab 40 includes a bonding portion 41 fixed to a rechargeable battery 10, and a supporting portion 42 protruding upward from the bonding portion 41 and thereby combining with the protective circuit board 20.

In a battery module according to the present exemplary embodiment, since a connecting member includes, as described above in the first exemplary embodiment, a first connecting tab 40, a second connecting tab, and a third connecting tab, and all the connecting tabs are the same in their structure, the description of the second and third connecting tabs is replaced with that of the first connecting tab 40 throughout this document.

A bonding portion 41a is disposed in parallel with a top side of the rechargeable battery 10 such that two bonding branches 41a and 41b are formed in the bonding portion 41.

The bonding branches 41a and 41b are integrally formed with the bonding portion 41, and are respectively disposed apart.

A bonding protrusion 47 to be welded to a terminal of the rechargeable battery 10 is formed at each bonding branch 41a and 41b.

In addition, a plurality of holes 48 may be formed in the bonding portion 41.

The supporting portion 42 which is bent in a vertical direction of the bonding portion 41 protrudes upward from the bonding portion 41, and catching protrusions 43 and 45 are formed protruding at a lateral side of the supporting portion 42.

The supporting portion 42 is inserted in a hole 23 formed in the protective circuit board 20, and protrudes above the protective circuit board 20.

These catching protrusions 43 and 45 are formed protruding from both lateral sides of the supporting portion 42 such that the two catching protrusions 43 and 45 are disposed apart at one lateral side of the supporting portion.

The protective circuit board 20 is inserted and fixed between the upper catching protrusion 43 and the lower catching protrusion 45.

The upper catching protrusion 43 passes through the hole 23, and is disposed above the hole 23 so as to support the protective circuit board 20 from above.

The lower catching protrusion 45 supports the protective circuit board 20 from below the hole 23. As a result, the protective circuit board 20 can be stably fixed by the upper catching protrusion 43 and the lower catching protrusion 45.

On the other hand, a protruding portion 46 for supporting the protective circuit board 20 from below is formed in the supporting portion 42.

The protruding portion 46 protrudes in a direction from a frontal side of the support portion 42 formed of a plate shape toward the bonding portion 41, and contacts a bottom side of the protective circuit board.

A part of the protruding portion 46 contacting the bottom side of the protective circuit board is formed in a flat plane shape.

Protruding portions and catching protrusions of the same structure, as in the first connecting tab, are formed in the second and third connecting tabs.

As a result, an extra holder is not required because the protective circuit board is stably supported by the connecting member including the protruding portion and the catching protrusion.

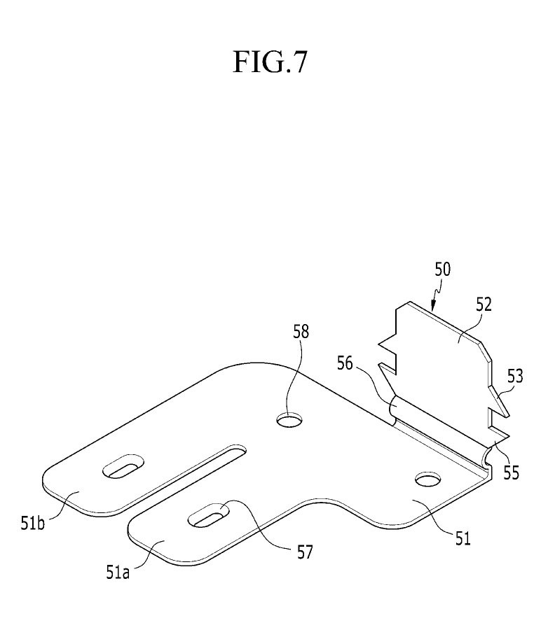

FIG. 7 is a perspective view of the first connecting tab according to a third exemplary embodiment.

Referring to FIG. 7, a first connecting tab 50 includes a bonding portion 51 fixed to a rechargeable battery 10, and a supporting portion 52 protruding upward from the bonding portion 51 and thereby combining with the protective circuit board 20.

In a battery module according to the present exemplary embodiment, since a connecting member includes, as described above in the first exemplary embodiment, the first connecting tab 50, the second connecting tab, and the third connecting tab, and all the connecting tabs are the same in their structure, the description of the second and third connecting tabs is replaced with that of the first connecting tab 50 throughout this document.

The bonding portion 51 is disposed in parallel with a top side of the rechargeable battery 10 such that two bonding branches 51a and 51b are formed in the bonding portion 51.

The bonding branches 51a and 51b are integrally formed with the bonding portion 51, and are respectively disposed apart.

A bonding protrusion 57 to be welded to a terminal of the rechargeable battery 10 is formed at each bonding branch of 51a and 51b.

In addition, a plurality of holes 58 may be formed in the bonding portion 51.

The supporting portion 52 which is bent in a vertical direction of the bonding portion 51 protrudes upward from the bonding portion 51, and catching protrusions 53 and 55 are formed protruding at a lateral side of the supporting portion 52.

The supporting portion 52 is inserted in a hole 23 formed in the protective circuit board 20, and protrudes above the protective circuit board 20.

These catching protrusions 53 and 55 are formed protruding from both lateral sides of the supporting portion 52 such that the two catching protrusions 53 and 55 are disposed apart at one lateral side of the supporting portion 52.

The protective circuit board 20 is inserted and fixed between the upper catching protrusion 53 and the lower catching protrusion 55.

The upper catching protrusion 53 passes through the hole 23 and is disposed above the hole 23 so as to support the protective circuit board 20 from above.

The lower catching protrusion 55 supports the protective circuit board 20 from below the hole 23.

As a result, the protective circuit board 20 can be stably fixed by the upper catching protrusion 53 and the lower catching protrusion 55.

On the other hand, a curved portion 56 for buffering vibration and impact is formed in the supporting portion 52.

The curved portion 56 is disposed below the catching protrusion 55, and is provided with a curved surface in a direction from a frontal side of the supporting portion 52 toward the bonding portion 51.

The curved portion 56 has an elastic feature such that it can buffer vibration and impact between the protective circuit board 20 and the bonding portion 51.

Protruding portions and catching protrusions of the same structure as in the first connecting tab are formed in the second and third connecting tabs.

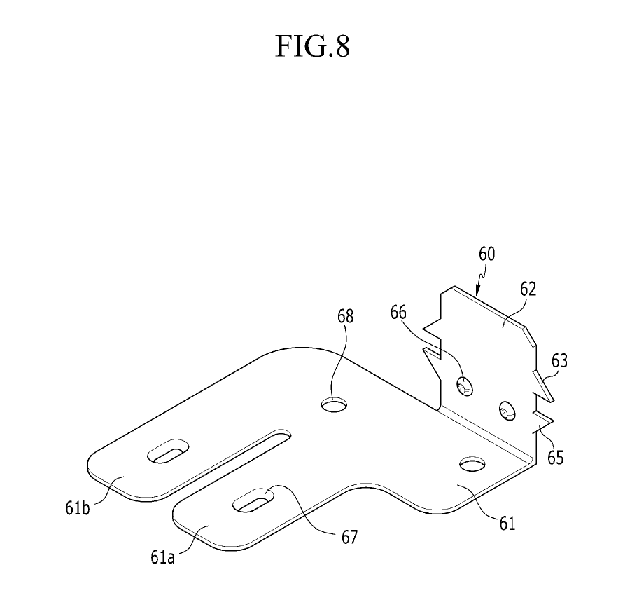

FIG. 8 is a perspective view of a first connecting tab according to a fourth exemplary embodiment.

Referring to FIG. 8, a first connecting tab 60 includes a bonding portion 61 fixed to a rechargeable battery 10, and a supporting portion 62 protruding upward from the bonding portion 61 and thereby combining with the protective circuit board.

In a battery module according to the present exemplary embodiment, since a connecting member includes, as described above in the first exemplary embodiment, a connecting tab 60, a second connecting tab, and a third connecting tab, and all the connecting tabs are the same in their structure, the description of the second and third connecting tabs is replaced with that of the first connecting tab 60 throughout this document.

The bonding portion 61 is disposed in parallel with a top side of the rechargeable battery 10 such that two bonding branches 61a and 61b are formed in the bonding portion 61.

The bonding branches 61a and 61b are integrally formed with the bonding portion 61, and are respectively disposed apart.

A bonding protrusion 67 to be welded to a terminal of the rechargeable battery 10 is formed at each bonding branch 61a and 61b.

In addition, a plurality of holes 68 may be formed in the bonding portion 61.

The supporting portion 62, which is bent in a vertical direction of the bonding portion 61, protrudes upward from the bonding portion 61, and catching protrusions 63 and 65 are formed protruding at a lateral side of the supporting portion 62.

The supporting portion 62 is inserted in a hole 23 formed in the protective circuit board 20, and protrudes above the protective circuit board 20.

These catching protrusions 63 and 65 are formed protruding from both lateral sides of the supporting portion 62 such that the two catching protrusions 63 and 65 are disposed apart at one lateral side in a height direction of the supporting portion.

The protective circuit board 20 is inserted and fixed between the upper catching protrusion 63 and the lower catching protrusion 65.

The upper catching protrusion 63 passes through the hole 23 and is disposed above the hole 23 so as to support the protective circuit board 20 from above.

The lower catching protrusion 65 supports the protective circuit board 20 from below the hole 23.

As a result, the protective circuit board 20 can be stably fixed by the upper catching protrusion 63 and the lower catching protrusion 65.

On the other hand, an embossed supporting protrusion 66 contacting a bottom side of the protective circuit board is formed in the supporting portion 62.

The embossed supporting protrusion 66 is fitted into a hole of the supporting portion 62, and protrudes from the supporting portion 62 so as to support the protective circuit board 20 from below.

The embossed supporting protrusion 66 which is made of a polymer material is detachable from the supporting portion 62.

Embossed supporting protrusions of the same structure as in the first connecting tab are formed in the second and third connecting tabs.

There may be more than two embossed supporting protrusions at each connecting tab.

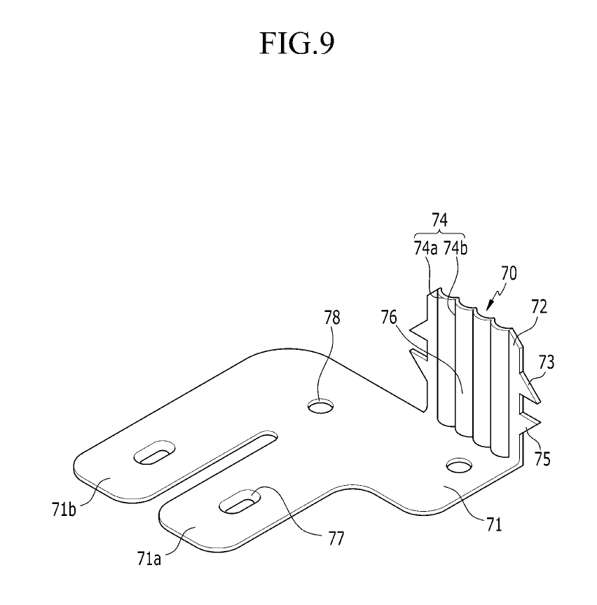

FIG. 9 is a perspective view of a first connecting tab according to a fifth exemplary embodiment.

Referring to FIG. 9, a first connecting tab 70 includes a bonding portion 71 fixed to a rechargeable battery 10, and a supporting portion 72 protruding upward from the bonding portion 71 and thereby combining with a protective circuit board 20.

In a battery module according to the present exemplary embodiment, since a connecting member includes, as described above in the first exemplary embodiment, a first connecting tab 70, a second connecting tab, and a third connecting tab, and all the connecting tabs are the same in their structure, the description of the second and third connecting tabs is replaced with that of the first connecting tab 70 throughout this document.

The bonding portion 71 is disposed in parallel with a top side of the rechargeable battery 10 such that two bonding branches 71a and 71b are formed in the bonding portion 71.

The bonding branches 71a and 71b are integrally formed with the bonding portion 71, and are respectively disposed apart.

A bonding protrusion 77 to be welded to a terminal of the rechargeable battery 10 is formed at each bonding branch 71a and 71b.

In addition, a plurality of holes 78 may be formed in the bonding portion 71.

The supporting portion 72 which is bent in a vertical direction of the bonding portion 71 protrudes upward from the bonding portion 71, and catching protrusions 73 and 75 are formed protruding at a lateral side of the supporting portion 72.

The supporting portion 72 is inserted in a hole 23 formed in the protective circuit board 20, and protrudes above the protective circuit board 20.

These catching protrusions 73 and 75 are formed protruding from both lateral sides of the supporting portion 72 such that the two catching protrusions 73 and 75 are disposed apart at one lateral side in a height direction of the supporting portion 72.

The protective circuit board 20 is inserted and fixed between the upper catching protrusion 73 and the lower catching protrusion 75.

The upper catching protrusion 73 passes through the hole 23, and is disposed above the hole 23 so as to support the protective circuit board 20 from above. The lower catching protrusion 75 supports the protective circuit board 20 from below the hole 23.

As a result, the protective circuit board 20 can be stably fixed by the upper catching protrusion 73 and the lower catching protrusion 75. On the other hand, a concavo-convex portion 74 is formed in the supporting portion 72.

The concavo-convex portion 74 includes a convex portion 74a and a recess portion 74b such that the convex portion 74a and the recess portion 74b are alternately arranged.

The supporting portion 72 is made in a plate shape with a thickness, a height, and a width, and the convex portion 74a and the recess portion 74b are formed extending in a height direction of the supporting portion.

In addition, a plurality of the recess portions 74b and convex portions 74a are alternately arranged along a width direction of the supporting portion 72.

Concavo-convex portions of the same structure, as in the first connecting tab, are formed in the second and third connecting tabs. Like the exemplary embodiment, when the concavo-convex portion 74 is formed in the supporting portion 72, it strengthens the rigidity of the supporting portion 72 such that the protective circuit board 20 can be more stably supported.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A battery module comprising:
a plurality of rechargeable batteries;
a protective circuit board having a circuit device controlling charging and discharging of the rechargeable batteries; and
a connecting tab combining the rechargeable batteries with the protective circuit board,
wherein the connecting tab has a catching protrusion that is inserted into a hole formed at the protective circuit board and thereby supports the protective circuit board.

2. The battery module of claim 1, wherein the connecting tab comprises a bonding portion fixed to a rechargeable battery and a supporting portion protruding upward from the bonding portion, and the catching protrusion is formed protruding at a lateral end of the supporting portion.

3. The battery module of claim 2, wherein two catching protrusions are formed to be disposed apart in a height direction of the supporting portion, and a lateral end of the protective circuit board is inserted between these catching protrusions.

4. The battery module of claim 2, wherein a bonding protrusion to be welded to the rechargeable battery is formed in the bonding portion.

5. The battery module of claim 2, wherein the connecting tab electrically connects neighboring rechargeable batteries.

6. The battery module of claim 2, wherein:
a lower tab for connecting the rechargeable batteries in series is installed at a lower part of the rechargeable batteries; and
the lower tab comprises a bonding portion fixed to the rechargeable batteries and a signal line protruding at the bonding portion and being inserted in the hole of the protective circuit board.

7. The battery module of claim 2, wherein a protruding portion contacting a bottom side of the protective circuit board is formed protruding in the supporting portion.

8. The battery module of claim 2, wherein a curved portion is formed curving in a direction from a frontal side of the supporting portion toward the bonding portion.

9. The battery module of claim 2, wherein an embossed supporting portion is fitted into the supporting portion and thereby contacts a bottom side of the protective circuit board.

10. The battery module of claim 2, wherein the supporting portion is formed with a concavo-convex portion with alternately arranged convex portions and recess portions.

11. The battery module of claim 10, wherein the convex portion and the recess portion are formed extending in a height direction of the supporting portion.

12. The battery module of claim 1, wherein a case in which the rechargeable batteries are stored is further provided, and the case comprises a first receiving portion and a second receiving portion, and a first fastener in a concavo-convex shape is formed in the first receiving portion such that a second fastener which is fitted into the first fastener is formed in the second receiving portion.

13. The battery module of claim 12, wherein a lower protrusion for supporting the rechargeable batteries from below is formed in the first and second receiving portion.

14. The battery module of claim 12, wherein a supporting protrusion for supporting the protective circuit board is formed in the case.

15. The battery module of claim 14, wherein a plurality of the supporting protrusions are formed to be disposed apart in a height direction of the case such that an end portion of the protective circuit board is inserted between these supporting protrusions.
